(19) United States
(12) Patent Application Publication
(10) Pub. No.: US 2013/0263523 A1
(43) Pub. Date: Oct. 10, 2013

(54) FUSED CERAMIC PARTICLE

(71) Applicants: Samuel Marlin, Plan D'Orgon (FR); Michela Valentini, L'Isle Sur La Sorgue (FR)

(72) Inventors: Samuel Marlin, Plan D'Orgon (FR); Michela Valentini, L'Isle Sur La Sorgue (FR)

(73) Assignee: SAINT-GOBAIN CENTRE DE RECHERCHES ET D'ETUDES EUROPEEN, Courbevoie (FR)

(21) Appl. No.: 13/879,250

(22) PCT Filed: Oct. 28, 2011
(86) PCT No.: PCT/IB2011/054798

§ 371 Date: Jun. 26, 2013

(30) Foreign Application Priority Data
Oct. 29, 2010 (FR) 10 58962

(51) Int. Cl. C04B 35/48

(52) U.S. Cl. CPC C04B 35/481
USPC 51/308; 65/21.2; 507/271; 501/134; 252/363.5; 252/71

(57) ABSTRACT

The present invention relates to a fused ceramic particle having the following chemical composition, as weight percentages based on the oxides, and for a total of 100%:
ZrO₂+HfO₂: balance to 100%;
5.0%<SiO₂<32.0%;
2.0%<La₂O₃<15.0%;
2.5%<Y₂O₃<11.0%;
0.5%<Al₂O₃<8.0%; and
less than 1.0% of other oxides.

Use in particular as a grinding agent, an agent for dispersion in a wet medium, a supporting agent, a heat-exchange agent, or for the treatment of surfaces.

### TECHNICAL FIELD

The present invention relates to novel fused ceramic particles, especially in the form of beads, to a process for manufacturing these beads, and to the use of these particles as grinding agents, agents for dispersion in a wet medium, or for surface treatment.

### PRIOR ART

The mineral industry uses particles for the fine grinding of materials that have optionally been pre-ground in the dry state using conventional processes, especially for calcium carbonate, titanium oxide, gypsum, kaolin and iron ore.

The paint, ink, dye, magnetic lacquer and agrochemical compound industries use such particles for dispersing and homogenizing the various liquid and solid constituents.

Finally, the surface treatment industry uses particles, in particular in operations for cleaning metallic molds (for manufacturing bottles for example), deburring parts, descaling, preparing a support with a view to coating it, shot peening, peen forming, etc.

Conventionally, the particles are substantially spherical and have a size of from 0.005 to 4 mm in order to serve all the markets described above. So that they can be used in these three types of applications, they must in particular have good wear resistance.

Various types of particles, particularly beads, are found on the market, especially in the field of microgrinding:
sand with rounded grains, such as OTTAWA sand for example, is a natural and cheap product but unsuitable for modern, pressurized and high-throughput mills. This is because the sand is not very strong, has a low density, varies in quality and is abrasive to the equipment;
glass beads, which are widely used, have a better strength, a lower abrasiveness and are available in a wider range of diameters; and
metallic beads, especially ones made of steel, have insufficient inertness with respect to the products treated, in particular leading to pollution of mineral fillers and graying of paints, and have a density that is too high, requiring special mills which results, in particular, in a high energy consumption, significant heating and high mechanical stressing of the equipment.

Beads made of a ceramic material are also known. These beads have a better strength than glass beads, a higher density and excellent chemical inertness. The following may be distinguished:
sintered ceramic beads, obtained by cold forming a ceramic powder and then consolidation by firing at high temperature; and
so-called “fused” ceramic beads, generally obtained by melting ceramic components, forming spherical drops from the molten material, then solidifying said drops.

The great majority of fused beads have a zirconia-silica (ZrO₂—SiO₂) type composition where the zirconia is crystallized in monoclinic form and/or partially stabilized in quadratic form (by suitable additions), and the silica and also some of the optional additives form a glassy phase binding the zirconia crystals. Fused ceramic beads offer optimum properties for grinding, namely good mechanical strength, high density, chemical inertness and low abrasiveness with respect to the grinding equipment.

Fused ceramic beads based on zirconia and their use for grinding and dispersion are, for example, described in FR 2 320 276 (U.S. Pat. No. 4,106,947) and EP 0 662 461 (U.S. Pat. No. 5,502,012). These documents describe the influence of SiO₂, Al₂O₃, MgO, CaO, Y₂O₃, CeO₂ and Na₂O on the main properties, especially on the compressive strength and abrasion resistance properties.

Although the fused ceramic beads of the prior art are of good quality, industry always needs products of even better quality. This is because the grinding conditions are becoming more and more demanding and it is necessary, in order to reduce the production costs, to increase the yields of the machines used. In particular, it is desirable to reduce the downtime of these machines.

The invention aims to meet these needs by providing fused ceramic particles which have excellent fracture strength and wear resistance, especially in a basic medium.

### SUMMARY OF THE INVENTION

The invention relates to a novel fused ceramic particle, preferably in the form of a bead, having the following chemical composition, as weight percentages based on the oxides, and for a total of 100%:
ZrO₂+HfO₂: balance to 100%;
15.0%<SiO₂<32.0%;
2.0%<La₂O₃<15.0%;
2.5%<Y₂O₃<11.0%;
0.5%<Al₂O₃<8.0%; and
less than 1.0% of other oxides.

The inventors have found, unexpectedly, that the presence of lanthanum oxide (La₂O₃) and yttrium oxide (Y₂O₃) in the aforementioned proportions significantly improves the properties of the fused ceramic particles, especially in comparison with the particles described in FR 2 320 276.

The particles according to the invention are thus particularly well suited to applications of dispersion in a wet medium, microgrinding and surface treatments. In the grinding application, the particles according to the invention have an improved fracture strength at the start and during use.

The invention also relates to a powder of particles comprising more than 90%, preferably more than 95%, preferably substantially 100%, as percentages by weight, of particles according to the invention.

The invention also relates to a process for manufacturing fused particles according to the invention, especially fused beads, comprising the following successive steps:
a) mixing raw materials to form a starting feedstock;
b) melting the starting feedstock until a molten material is obtained;
c) dispersing said molten material in the form of liquid droplets and solidifying these liquid droplets in the form of particles (especially beads).

According to the invention, the raw materials are chosen in step a) so that the particles obtained in step c) comply with the invention. Preferably, oxides of lanthanum, yttrium and aluminum and/or one or more precursors of these oxides are added intentionally and systematically to the starting feedstock, preferably in oxide form, so as to guarantee this compliance.

The invention lastly relates to the use of a powder of particles, especially of beads, according to the invention, especially ones that are manufactured according to a process according to the invention, as grinding agents; agents for dispersion in a wet medium; propping agents, in particular for preventing the closure of deep geological fractures created in the walls of an extraction well, in particular an oil well; heat-exchange agents for example for a fluidized bed; or for surface treatment.

Definitions
The term “particle” is understood to mean an individualized solid product in a powder.
The term “bead” is understood to mean a particle having a sphericity, that is to say a ratio between its smallest diameter and its largest diameter, of greater than 0.6, regardless of the way in which this sphericity was obtained. Preferably, the beads according to the invention have a sphericity of greater than 0.7.
The “size” of a bead (or of a particle) refers to the average of its largest dimension dM and of its smallest dimension dm: (dM+dm)/2.
The expression “fused bead”, or more commonly “fused particle”, is understood to mean a solid bead (or particle) obtained by solidification by cooling a molten material.
A “molten material” is a liquid mass that may contain some solid particles, but in an insufficient amount for them to be able to structure said mass. In order to retain its shape, a molten material must be contained in a container.
The term “impurities” is understood to mean the inevitable constituents necessarily introduced with the raw materials. In particular, in one embodiment, the compounds that belong to the group of oxides, nitrides, oxynitrides, carbides, oxycarbides, carbonitrides and metallic species of sodium and other alkali metals, iron, vanadium and chromium are impurities. As examples, mention may be made of MgO, CaO, Fe₂O₃, TiO₂ or Na₂O. The residual carbon is part of the impurities of the composition of the particles according to the invention.
When reference is made to zirconia or to ZrO₂, it should be understood as (ZrO₂+HfO₂), that is to say ZrO₂ and traces of HfO₂. Indeed, a small amount of HfO₂, chemically indissociable from ZrO₂ in a melting process and having similar properties, is always naturally present in sources of zirconia at contents generally of less than 2%. Hafnium oxide is not considered to be an impurity.
The term “precursor” of an oxide is understood to mean a constituent capable of providing said oxide during the manufacture of a particle according to the invention.

All of the percentages of the present description are weight percentages on the basis of the oxides, unless otherwise mentioned.

### BRIEF DESCRIPTION OF THE FIGURES

Other features and advantages will also appear on reading the detailed description which follows and on examining the appended drawing in which:

FIG. 1 represents an image of the reference product from the examples; and

FIG. 2 represents an image of the product from example 8.

### DETAILED DESCRIPTION

Process

In order to manufacture a product according to one embodiment of the invention, it is possible to carry out the following steps a) to c) mentioned above.

These steps are conventional, except as regards the composition of the starting feedstock, and a person skilled in the art knows how to adapt them as a function of the targeted application.

A preferred embodiment of this process is now described.

In step a), the starting feedstock is formed of the oxides indicated or of precursors thereof. Preferably, use is made of natural zircon sand ZrSiO₄ containing around 66% of ZrO₂ and 33% of SiO₂, plus impurities. The introduction of ZrO₂ and SiO₂ in the form of zircon is indeed much more economical than an addition in the form of free zirconia and silica.

The compositions can be adjusted by adding pure oxides, mixtures of oxides or mixtures of precursors of these oxides, in particular by addition of ZrO₂, SiO₂, La₂O₃, Y₂O₃ and Al₂O₃.

According to the invention, a person skilled in the art adjusts the composition of the starting feedstock so as to obtain, at the end of step c), particles that comply with the invention. The chemical analysis of the fused ceramic particles according to the invention is generally substantially identical to that of the starting feedstock. In addition, where appropriate, for example to take into account the presence of volatile oxides, or to take into account the loss of SiO₂ when the fusion is carried out under reducing conditions, a person skilled in the art knows how to adapt the composition of the starting feedstock accordingly.

Preferably, no raw material other than those providing ZrO₂+HfO₂, SiO₂, La₂O₃, Al₂O₃, Y₂O₃ and precursors thereof is intentionally introduced into the starting feedstock, the other oxides present being impurities.

In step b), the starting feedstock is melted, preferably in an electric arc furnace. Indeed, the electrofusion enables the manufacture of large amounts of particles (preferably in the form of beads) with advantageous yields. However, all known furnaces can be envisaged, such as an induction furnace or a plasma furnace, provided that they make it possible to virtually completely melt the starting feedstock.

In step c), a stream of the molten liquid is dispersed in small liquid droplets, most of which, due to the surface tension, assume a substantially spherical shape. This dispersion may be carried out by blowing, especially with air and/or steam and/or nitrogen, or by any other process for spraying a molten material, known to a person skilled in the art. A fused ceramic particle having a size of from 0.005 to 4 mm may thus be produced.

The cooling resulting from the dispersion leads to the solidification of the liquid droplets. Fused particles, in particular fused beads, according to the invention are then obtained.

Any conventional process for manufacturing fused particles, especially fused beads, may be used, provided that the composition of the starting feedstock makes it possible to obtain particles having a composition that complies with that of the particles according to the invention. For example, it is possible to manufacture a molten and cast block, then to grind it and, where appropriate, to carry out a particle size selection.

Particles

A fused ceramic particle according to the invention has the following chemical composition, as weight percentages based on the oxides, and for a total of 100%:

ZrO₂+HfO₂: balance to 100%;

15.0%<SiO₂<32.0%;

2.0%<La₂O₃<15.0%;

2.5%<Y₂O₃<11.0%;

0.5%<Al₂O₃<8.0%; and

less than 1.0% of other oxides.

A fused ceramic particle according to the invention preferably has a weight content of La₂O₃ of greater than 2.5%, greater than 3.0%, greater than 4.0%, or even greater than 5.0%.

Preferably, the weight content of La₂O₃ is less than 14.0%, less than 12.0%, less than 10.0%, less than 9.5%, or even less than 9.0%.

In one embodiment, the weight content of yttrium oxide Y₂O₃ is greater than 3.0%, greater than 3.5%, greater than 4.0%, or even greater than 4.5% and/or less than 10.0%, less than 9.0%, less than 8.5%, or even less than 8.0%, less than 7.5%, less than 7.0%.

Similarly, a fused ceramic particle according to the invention preferably has a weight content of Al₂O₃ of greater than 0.8%, preferably greater than 1.0%, greater than 1.2%, greater than 1.5%, greater than 1.6%, or even greater than 1.8%.

The weight content of Al₂O₃ is preferably less than 7.0%, less than 6.5%, less than 6.0% or less than 3.5%.

The contents of zirconia and of silica also influence the performances of a particle according to the invention.

Preferably, a fused ceramic particle according to the invention comprises a weight content of ZrO₂ of greater than 50.0%, greater than 51.0%, greater than 52.0%, or even greater than 53.0%. Preferably, this weight content is less than 70.0%, less than 65.0%, preferably less than 63.0%, or even less than 60.0% or less than 58.0%.

Preferably, a fused ceramic particle according to the invention comprises a weight content of SiO₂ of greater than 16.0%, greater than 18.0%, preferably greater than 20.0%, more preferably greater than 22.0% and preferably greater than 24.0%. Preferably, this weight content is less than 31.0%, less than 30.0%, less than 29.0% and preferably less than 28.0%.

Preferably, a fused ceramic particle according to the invention has a ratio of the ZrO₂/SiO₂ weight percentages of greater than 1.5, or even greater than 1.8, or even greater than 2.0 or greater than 2.1, and/or less than 4.0, less than 3.0 and preferably less than 2.5.

Preferably, a fused ceramic particle according to the invention has a ratio of the Al₂O₃/SiO₂ weight percentages of greater than 0.05, and/or less than 0.25, less than 0.20 and preferably less than 0.15.

The “other oxides” are preferably only present in the form of impurities. It is considered that a total content of “other oxides” of less than 1.0% does not substantially modify the results obtained. However, preferably, the content of “other oxides”, as a weight percentage based on the oxides, is less than 0.6%, preferably less than 0.5%, preferably less than 0.45%.

Still preferably, the content of oxides of a particle according to the invention represents more than 99.5%, preferably more than 99.9%, and, more preferably, substantially 100% of the total weight of said particle.

A preferred particle according to the invention has the following chemical composition, as weight percentages based on the oxides, and for a total of 100%:
ZrO₂+HfO₂: balance to 100%, preferably 51.0%<ZrO₂+HfO₂<63.0%;
20.0%<SiO₂<30.0%;
2.5%<La₂O₃<10.0%;
3.0%<Y₂O₃<7.5%;
1.5%<Al₂O₃<5.5%; and
less than 1.0% of other oxides.

A preferred particle according to the invention has the following chemical composition, as weight percentages based on the oxides, and for a total of 100%:
ZrO₂+HfO₂: balance to 100%, preferably 52.0%<ZrO₂+HfO₂<63.0%;
22.0%<SiO₂<28.0%;
3.0%<La₂O₃<10.0%;
4.0%<Y₂O₃<7.5%;
1.8%<Al₂O₃<3.5%; and
less than 1.0% of other oxides.

A fused ceramic particle according to the invention may in particular have a size of less than 4 mm and/or greater than 0.005 mm.

Shapes other than those of the “beads” are possible according to the invention, but the substantially spherical shape is preferred.

The fused ceramic particles according to the invention are highly wear resistant.

In the case of stresses in a highly basic medium, that is to say for pH values>8, for example for the grinding of calcium carbonate suspensions, such particles are particularly suitable since they have a high wear resistance coupled with a good resistance to the chemical attack of the medium in which the grinding is carried out.

The fused ceramic particles according to the invention are particularly suitable as grinding agents or as agents for dispersion in a wet medium, and also for the treatment of surfaces. The invention therefore also relates to the use of a plurality of particles, in particular of beads according to the invention, or of beads manufactured according to a process according to the invention, as grinding agents, or agents for dispersion in a wet medium.

It may however be noted that the properties of the beads, especially their strengths, their density and also the ease of obtaining them, may make them suitable for other applications, especially as propping or heat-exchange agents or else for the treatment of surfaces.

The invention therefore also relates to a device chosen from a suspension, a mill, a surface treatment apparatus and a heat exchanger, said device comprising a powder of particles according to the invention.

### EXAMPLES

The following non-limiting examples are given for the purpose of illustrating the invention.

Measurement Protocols

The following methods were used to determine certain properties of various mixtures of fused ceramic beads. They enable an excellent simulation of the actual behavior, in operation, in the grinding application.

In order to determine the wear resistance known as “planetary” wear resistance, 20 ml (volume measured using a graduated cylinder) of beads to be tested having a size between 0.8 and 1 mm are weighed (mass mₒ) and introduced into one of 4 bowls coated with dense sintered alumina, having a capacity of 125 ml, of a RETSCH PM400 rapid planetary mill. Added to the same bowl that already contains the beads are 2.2 g of Presi silicon carbide (having a median size D50 of 23 μm) and 40 ml of water. The bowl is sealed and rotated (planetary movement) at 400 rpm with reversal of the direction of rotation at one minute intervals for 1 h 30 min. The contents of the bowl is then washed over a 100 μm screen so as to remove the residual silicon carbide and also the material removed due to wear during the grinding operation. After screening over a 100 μm screen, the particles are dried in an oven at 100° C. for 3 h, and then weighed (mass m).

The planetary wear is expressed as a percentage (%) and is equal to the loss of mass of the beads relative to the initial mass of the beads, namely: 100(m₀−m)/(m₀); the result PW is given in table 1.

It is considered that the results are particularly satisfactory if the products have an improvement in the planetary wear (PW) resistance of at least 20% relative to that of Ref. example 1.

In order to determine the wear resistance known as “wear resistance in a basic medium”, that is to say wear in media having a pH greater than 8, a charge of beads to be tested is screened between 0.6 and 0.8 mm through square-mesh screens. A bulk volume of 1.04 l of beads is weighed (mass m′₀). The beads are then introduced into a Netzsch LME1 horizontal mill (working volume of 1.2 l) having off-center steel disks. An aqueous suspension of calcium carbonate CaCO₃, having a pH equal to 8.2, containing 70% of solids and of which 40% of the grains by volume are less than 1 μm, passes continuously through the mill, with a throughput of 4 liters an hour. The mill is started gradually until a linear speed at the end of the disks of 10 m/s is achieved. The mill is kept in operation for a time t, between 16 and 24 hours, then stopped. The beads are rinsed with water, carefully removed from the mill, then washed and dried. They are then weighed (mass m′). The rate of wear V in grams/hour is determined as follows:

V=(m′₀−m′)/t.

The charge of beads is taken up and topped up with (m′ₒ−m′) grams of new beads so as to repeat the grinding operation as many times as necessary (n times) so that the accumulated grinding time is at least 100 hours and the difference between the rate of wear calculated in step n and in step n-1 is less than 15% in relative terms. The wear in a basic medium is the rate of wear measured in this stabilized situation (typically over 120 hours). The result BW is given in table 1.

It is considered that the results are particularly satisfactory if the products have an improvement in the wear resistance in a basic medium (BW) of at least 20% relative to that of Ref. example 1.

Manufacturing Protocol

In the examples, use is made of a composition based on zircon for the starting feedstock and lanthanum oxide, yttrium oxide and aluminum oxide are added. This starting feedstock is melted in an electric arc furnace of Heroult type. The molten material is then dispersed into beads by blowing with compressed air.

Several melting/casting cycles are carried out by adjusting, in particular, the contents of oxides of lanthanum, of yttrium and of alumina.

Results

The results obtained are summarized in table 1 below.

TABLE 1

| | ZrO₂ + HfO₂ | | | | | | | | | |
|---|---|---|---|---|---|---|---|---|---|---|
| | and impu- | SiO₂ | La₂O₃ | Y₂O₃ | Al₂O₃ | | PW | PW % | BW | BW % |
| Ex | rities in % | in % | in % | in % | in % | ZrO₂/SiO₂ | in % | ref 1 | in g/h | ref 1 |
| Ref. 1 | Balance to | 29.3 | | | 1.9 | 2.3 | 5.7 | | 4.1 | |
| 1* | 100% | 26.1 | 3.7 | 1.9 | 2 | 2.3 | 5.7 | 0% | ND | ND |
| 2* | | 26 | 9.1 | 0.1 | 3.1 | 2.3 | 5.8 | −2% | ND | ND |
| 3 | | 25.7 | 8.7 | 2.7 | 2.7 | 2.3 | 3.6 | 37% | ND | ND |
| 4 | | 27.9 | 3.6 | 3.2 | 2.6 | 2.2 | 3.2 | 44% | 2.3 | 44% |
| 5 | | 24.6 | 8.9 | 4.2 | 2.6 | 2.4 | 2.4 | 58% | ND | ND |
| 6 | | 27.4 | 5.3 | 4.8 | 2.6 | 2.2 | 1.9 | 67% | ND | ND |
| 7 | | 25.1 | 9.1 | 4.7 | 2 | 2.3 | 1.9 | 67% | ND | ND |
| 8 | | 24.5 | 9.6 | 5.8 | 5 | 2.2 | 1.8 | 68% | 1.3 | 68% |
| 9 | | 24.5 | 8.6 | 6.2 | 2.5 | 2.3 | 1.7 | 70% | ND | ND |
| 10 | | 24.3 | 8.9 | 10.9 | 2.38 | 2.2 | 2.9 | 49% | ND | ND |
| 11* | | 28.6 | 3.4 | | 2.8 | 2.2 | 5.8 | −2% | 3.1 | 24% |
| 12 | | 26.5 | 3.8 | 5.4 | 5 | 2.2 | 2.4 | 58% | 1.8 | 56% |

ND: Not determined
*example outside of the invention

The impurities represent, for each example, less than 1%.

The reference beads from the example “Ref. 1”, outside of the invention, are beads commonly used in the grinding applications. The examples show that, surprisingly, the beads according to the invention that were tested have remarkable performances compared to the reference beads.

The comparison of example 4 with example 11 outside of the invention shows the synergistic effect originating from the addition of yttrium oxide and lanthanum oxide.

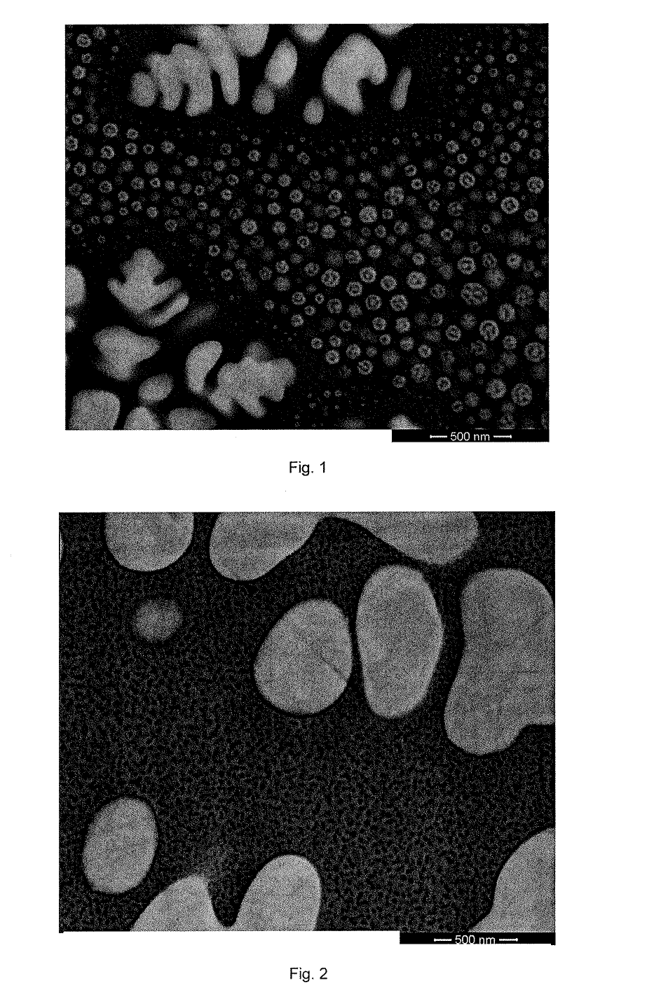

Analyses of the structure using a scanning electron microscope were carried out on the reference sample (FIG. 1) and also for example 8 (FIG. 2). The largest white zones correspond to zirconia dendrites, the remainder constitutes the silicate phase with the silica in black. It is observed that the silicate phase of the product according to the invention is very different from that of the reference product. The silicate phase of the product of the example according to the invention indeed consists of a continuous network of small crystals comprising ZrO₂, La₂O₃, Y₂O₃ and Al₂O₃, whereas that of the reference product comprises only small crystals of zirconia dispersed discontinuously.

In one embodiment, a particle according to the invention thus has a microstructure comprising zirconia dendrites, preferably having a length of greater than 2 μm, greater than 3 μm, or greater than 5 μm, embedded in a silicate phase comprising crystals of ZrO₂, La₂O₃, Y₂O₃ and Al₂O₃ having a length of less than 0.3 μm, of less than 0.2 μm, or even of less than 0.1 μm. Preferably, the crystals of ZrO₂, La₂O₃, Y₂O₃ and Al₂O₃ are distributed within the silicate phase so as to form a continuous network. Preferably, more than 50%, more than 70%, or even more than 80% of these crystals are in contact with other crystals.

Of course, the present invention is not limited to the embodiments described or represented, provided by way of illustrative examples.

1. A fused ceramic particle having the following chemical composition, as weight percentages based on the oxides, and for a total of 100%:
ZrO₂+HfO₂: balance to 100%;
15.0%<SiO₂<32.0%;
2.0%<La₂O₃<15.0%;
2.5%<Y₂O₃<11.0%;
0.5%<Al₂O₃<8.0%; and
less than 1.0% of other oxides.

2. The particle as claimed in claim 1, wherein:
La₂O₃<10.0%.

3. The particle as claimed in claim 1, wherein:
Y₂O₃>3.0%.

4. The particle as claimed in claim 1, wherein:
Y₂O₃<10.0%.

5. The particle as claimed in claim 4, wherein:
Y₂O₃<7.5%.

6. The particle as claimed in claim 1, wherein:
Al₂O₃>1.5%.

7. The particle as claimed in claim 1, wherein:
Al₂O₃<7.0%.

8. The particle as claimed in claim 7, wherein:
Al₂O₃<6.0%.

9. The particle as claimed in claim 1, wherein:
ZrO₂>52.0%.

10. The particle as claimed in claim 1, wherein:
SiO₂>20.0%.

11. The particle as claimed in claim 1, having the following chemical composition, as weight percentages based on the oxides, and for a total of 100%:
ZrO₂+HfO₂: balance to 100%;
20.0%<SiO₂<30.0%;
2.5%<La₂O₃<10.0%;
3.0%<Y₂O₃<7.5%;
1.5%<Al₂O₃<5.5%; and
less than 1.0% of other oxides.

12. The particle as claimed in claim 1, wherein:
2.5>ZrO₂/SiO₂>1.5.

13. The particle as claimed in claim 1, wherein:
La₂O₃>3.0%.

14. The particle as claimed in claim 1, wherein:
Y₂O₃>3.5%.

15. The particle as claimed in claim 14, wherein:
Y₂O₃>4.5%.

16. The particle as claimed in claim 1, wherein:
Al₂O₃<3.5%.

17. The particle as claimed in claim 1, wherein:
2.5>ZrO₂/SiO₂>2.0.

18. The particle as claimed in claim 1 wherein:
SiO₂>22.0%.

19. A process for manufacturing a powder of particles as claimed in claim 1, comprising the following successive steps:
a) mixing raw materials to form a starting feedstock;
b) melting the starting feedstock until a molten material is obtained;
c) dispersing said molten material in the form of liquid droplets and solidifying these liquid droplets in the form of solid particles,
in which process the raw materials are chosen in step a) so that the particles obtained in step c) comply with any one of the preceding claims, oxides of lanthanum, yttrium and aluminum and/or one or more precursors of these oxides being added intentionally and systematically to the starting feedstock.

20. A grinding agent or an agent for dispersion in a wet medium comprising the particle of claim 1.

21. A propping agent or a heat exchange agent comprising the particle of claim 1.
